(19) United States
(12) Patent Application Publication
(10) Pub. No.: US 2026/0112671 A1
(43) Pub. Date: Apr. 23, 2026

(54) FUEL CELL SYSTEM

(71) Applicant: TOYOTA JIDOSHA KABUSHIKI KAISHA, Toyota-shi (JP)

(72) Inventor: Hiroyuki SUGANUMA, Aichi-gun (JP)

(73) Assignee: TOYOTA JIDOSHA KABUSHIKI KAISHA, Toyota-shi (JP)

(21) Appl. No.: 19/330,431

(22) Filed: Sep. 16, 2025

(30) Foreign Application Priority Data
Oct. 21, 2024 (JP) 2024-185111

(51) Int. Cl. H01M 8/04992; H01M 8/04089; H01M 8/04746

(52) U.S. Cl. CPC H01M 8/04992; H01M 8/04089; H01M 8/04753

(57) ABSTRACT

A fuel cell system includes a fuel cell, an injector that injects fuel gas to the fuel cell, a linear solenoid valve that injects fuel gas to the fuel cell, an injection flow rate of fuel gas from the linear solenoid valve being greater than an injection flow rate of fuel gas from the injector, and a control device configured to control the injector and the linear solenoid valve. The control device is configured to include a switching unit, an operation control unit, an integration unit, and a reduction control unit.

### CROSS-REFERENCE TO RELATED APPLICATION

This application is based upon and claims the benefit of priority of the prior Japanese Patent Application No. 2024-185111, filed on Oct. 21, 2024, the entire contents of which are incorporated herein by reference.

### TECHNICAL FIELD

The present disclosure relates to a fuel cell system.

### BACKGROUND

There is a fuel cell system including a fuel cell, an injector that injects fuel gas to the fuel cell, and a linear solenoid valve that injects fuel gas to the fuel cell and has a larger injection flow rate of fuel gas than the injector (see Japanese Unexamined Patent Application Publication No. 2020-087520).

When the number of operations of the injector becomes excessive, the life of the injector might be shortened.

### SUMMARY

It is therefore an object of the present disclosure to provide a fuel cell system in which a life of an injector for injecting fuel gas is improved.

The above object is achieved by a fuel cell system including: a fuel cell; an injector that injects fuel gas to the fuel cell; a linear solenoid valve that injects fuel gas to the fuel cell, an injection flow rate of fuel gas from the linear solenoid valve being greater than an injection flow rate of fuel gas from the injector; and a control device configured to control the injector and the linear solenoid valve, wherein the control device is configured to include: a switching unit configured to operate the injector when a required amount of power generation of the fuel cell is less than a switching value, and to operate the linear solenoid valve when the required amount of power generation is equal to or greater than the switching value; an operation control unit configured to operate the injector when the required amount of power generation is less than the switching value and a supply pressure of the fuel gas supplied to the fuel cell is decreased to be equal to or smaller than a lower limit value, and to stop the operation of the injector when the required amount of power generation is less than the switching value and the supply pressure is increased to be equal to or greater than an upper limit value; an integration unit configured to integrate the number of operations of the injector; and a reduction control unit configured to execute reduction control to reduce the number of operations of the injector when the number of operations is equal to or larger than a threshold value, as compared with when the number of operations is smaller than the threshold value.

The reduction control may be configured to change the upper limit value to a higher value while maintaining the lower limit value when the number of operations is equal to or greater than the threshold value, as compared with when the number of operations is less than the threshold value.

The reduction control may be configured to change the switching value to a lower value when the number of operations is equal to or larger than the threshold value, as compared with when the number of operations is smaller than the threshold value.

The reduction control may be configured to change the upper limit value to a higher value and to change the switching value to a lower value while maintaining the lower limit value when the number of operations is equal to or greater than the threshold value, as compared with when the number of operations is less than the threshold value.

The control device may include a notification control unit configured to notify that the number of operations is equal to or larger than the threshold value when the number of operations is equal to or larger than the threshold value.

### BRIEF DESCRIPTION OF THE DRAWINGS

FIG. 1 is a configuration view of a fuel cell system;

FIG. 2 is a flowchart illustrating reduction control executed by an ECU;

FIG. 3 is a timing chart illustrating an upper limit value changing process; and

FIG. 4 is a timing chart illustrating a switching value changing process.

### DETAILED DESCRIPTION

### Configuration of Fuel Cell System

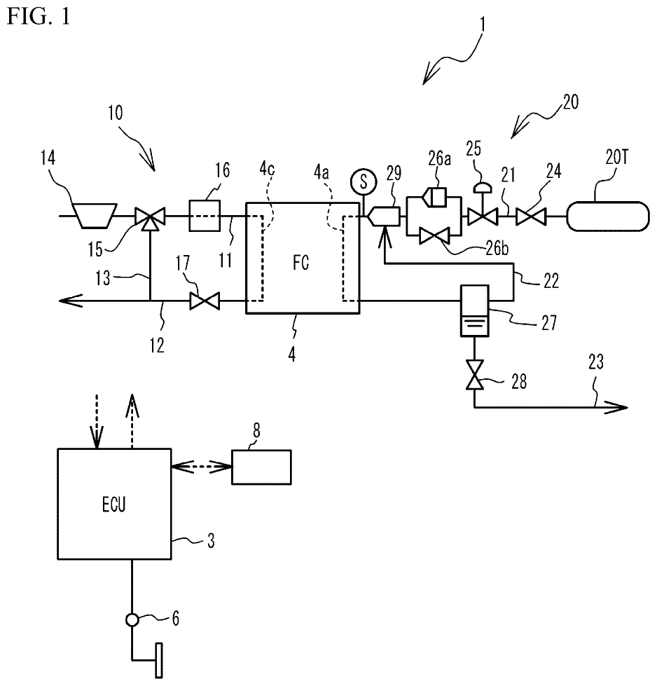

FIG. 1 is a configuration view of a fuel cell system 1. The fuel cell system 1 is mounted on a vehicle and includes an electronic control unit (ECU) 3, a fuel cell (hereinafter, referred to as FC) 4, an oxidant gas supply system 10, and a fuel gas supply system 20. The fuel cell system 1 is mounted on a vehicle. The electric power generated in the FC 4 is supplied to a motor as a driving source for traveling.

The FC 4 is formed by stacking a plurality of solid polymer electrolyte-type unit cells that generate electric power upon receiving supply of an oxidant gas and a fuel gas. A cathode flow path 4c through which the oxidant gas flows and an anode flow path 4a through which the fuel gas flows are formed in the FC 4. The unit cell is constituted by a membrane electrode assembly, and a cathode-side separator and an anode-side separator which sandwich the membrane electrode assembly. The cathode flow path 4c is a space which is mainly defined between the membrane-electrode assembly and the cathode-side separators and through which the oxidant gas flows. The anode flow path 4a is a space defined between the membrane-electrode assembly and the anode-side separators, and through which the fuel gas flows. The membrane electrode assembly includes an electrolyte membrane and catalyst layers formed on both surfaces of the electrolyte membrane.

The oxidant gas supply system 10 supplies oxygen-containing air as oxidant gas to the FC 4, and includes a supply pipe 11, a discharge pipe 12, a bypass pipe 13, an air compressor 14, a bypass value 15, an intercooler 16, and a back pressure value 17. The supply pipe 11 is connected to an inlet of the cathode flow path 4c of the FC 4. The discharge pipe 12 is connected to an outlet of the cathode flow path 4c of the FC 4. The bypass pipe 13 communicates the supply pipe 11 and the discharge pipe 12. The bypass valve 15 is provided at a connection portion between the supply pipe 11 and the bypass pipe 13. The bypass valve 15 switches a communication state between the supply pipe 11 and the bypass pipe 13. The air compressor 14, the bypass valve 15, and the intercooler 16 are arranged in this order from the upstream side on the supply pipe 11. The back pressure valve 17 is disposed on the discharge pipe 12 and on the upstream side of the connection portion between the discharge pipe 12 and the bypass pipe 13. The air compressor 14 supplies oxygen-containing air as the oxidant gas to the FC 4 via the supply pipe 11. The oxidant gas supplied to the FC 4 is discharged through the discharge pipe 12. The intercooler 16 cools the oxidant gas supplied to the FC 4. The back pressure valve 17 adjusts the back pressure on the cathode side of the FC 4. The air compressor 14, the bypass valve 15, and the back pressure valve 17 are controlled by the ECU 3. The opening degrees of the bypass valve 15 and the back pressure valve 17 are adjusted by the ECU 3. Thus, the flow rate of the oxidant gas supplied from the air compressor 14 to the FC 4 is adjusted.

The fuel gas supply system 20 supplies the fuel gas to the FC 4, and includes a tank 20T, a supply pipe 21, a circulation pipe 22, a discharge pipe 23, a tank valve 24, a pressure regulating valve 25, an injector (hereinafter, referred to as INJ) 26a, a linear solenoid valve (hereinafter, referred to as LSV) 26b, a pressure-sensor S, a gas-liquid separator 27, a discharge valve 28, and a multi-nozzle ejector (hereinafter, referred to as MEJ) 29. The tank 20T and the inlet of the anode flow path 4a of the FC 4 are connected by the supply pipe 21. The tank 20T stores a hydrogen-containing gas as a fuel gas. The tank valve 24, the pressure regulating valve 25, the INJ 26a and the LSV 26b, and the MEJ 29 are arranged in this order from the upstream side of the supply pipe 21. The INJ 26a and the LSV 26b are provided at portions of the supply pipe 21 which are partially branched from each other. The sensor S detects the supply pressure value P of the fuel gas supplied from at least one of the INJ 26a and the LSV 26b to the FC 4. The supply pressure value P is a pressure in the supply pipe 21 on the downstream side of the INJ 26a and the LSV 26b. The supply pressure value P corresponds to a pressure at the inlet of the FC 4. The opening degree of the pressure regulating valve 25 is adjusted in a state where the tank valve 24 is opened. The fuel gas is injected by operating at least one of the INJ 26a and the LSV 26b. The injected fuel gas is supplied to the FC 4 through the MEJ 29.

The INJ 26a is an on-off value that controls the opening degree of the injection port only to a fully closed opening degree and a fully opened opening degree. The diameter of the injection port of the INJ 26a is smaller than the diameter of an injection port of the LSV 26b. Thus, the injection flow rate of the INJ 26a is smaller than the injection flow rate of the LSV 26b. The injection flow rate is a flow rate of the fuel gas injected per unit time.

The LSV 26b is driven by a linear solenoid to open and close the injection port. The LSV 26b is controlled to maintain the opening degree of the injection port at a predetermined opening degree between a fully closed opening degree and a fully opened opening degree. In this way, the injection flow rate of the fuel gas from the LSV 26b is adjusted to a predetermined amount. The opening degree of the LSV 26b is adjusted according to a required power generation amount W of the FC 4.

The circulation pipe 22 connects the outlet of the anode flow path 4a of the FC 4 and the MEJ 29. The circulation pipe 22 is provided with the gas-liquid separator 27. The circulation pipe 22 is a pipe for returning the fuel gas to the FC 4. The fuel gas injected from at least one of the INJ 26a and the LSV 26b passes through the MEJ 29, whereby a negative pressure is generated in the MEJ 29. The fuel off-gas discharged from the FC 4 by this negative pressure is sucked into the MEJ 29 via the gas-liquid separator 27. Thus, the fuel off-gas discharged from the FC 4 is supplied to the FC 4.

The discharge pipe 23 is connected to the gas-liquid separator 27. The discharge pipe 23 is provided with the discharge valve 28. The gas-liquid separator 27 separates water from the fuel off-gas discharged from the FC 4 and stores the water. The water and the fuel off-gas stored in the gas-liquid separator 27 are discharged to the outside of the fuel cell system 1 through the discharge pipe 23 by opening the discharge valve 28. The tank valve 24, the pressure regulating valve 25, the INJ 26a, the LSV 26b, and the discharge valve 28 are controlled by the ECU 3.

The ECU 3 includes a central processing unit (CPU), a read only memory (ROM), and a random access memory (RAM). An accelerator opening sensor 6, a display 8, the air compressor 14, the bypass valve 15, the back pressure valve 17, the tank valve 24, the pressure regulating valve 25, the INJ 26a, the LSV 26b, and the discharge valve 28 are electrically connected to the ECU 3.

The ECU 3 calculates the required power generation amount W of the FC 4 based on the detection value of the accelerator opening sensor 6, the driving states of auxiliary machines of the vehicle and auxiliary machines of the FC 4, and the like. The ECU 3 calculates a target current value of the FC 4 according to the required power generation amount W of the FC 4. The ECU 3 controls the flow rates of the oxidant gas and the fuel gas supplied to the FC 4 by the air compressor 14, the INJ 26a, or the LSV 26b so that the current outputted from the FC 4 becomes equal to the target current. The display 8 is provided on, for example, an instrument panel of the vehicle. The ECU 3 functionally realizes a switching unit, an operation control unit, an integration unit, a reduction control unit, and a notification control unit, thereby executing reduction control described below.

### Reduction Control

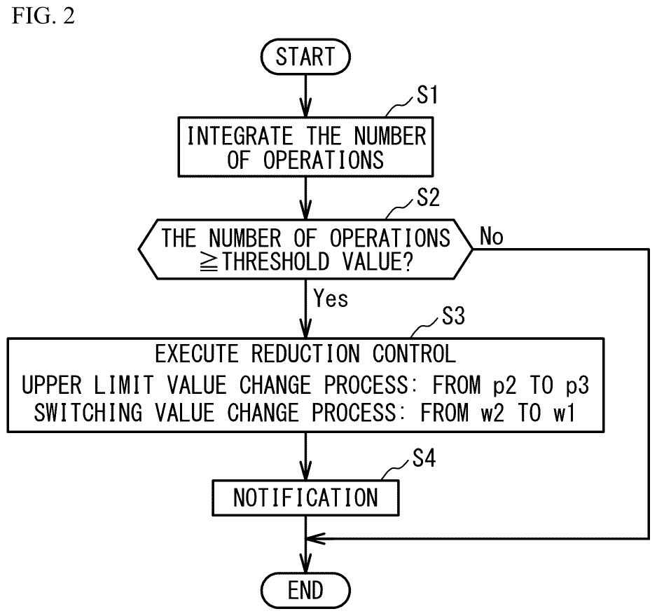

FIG. 2 is a flowchart illustrating an example of reduction control performed by the ECU 3. The ECU 3 integrates the number of operations of the INJ 26a (step S1). The number of operations of the INJ 26a is the number of times of opening of the INJ 26a. The number of operations in the present trip is integrated by adding the number of operations integrated in the previous trip. Step S1 is an example of a process executed by the integration unit.

Next, the ECU 3 determines whether the integrated number of operations is equal to or greater than a threshold value (step S2). The threshold value is set to a number of times lower by a predetermined number of times than the number of operations requiring replacement of the INJ 26a. If the determination result is No in step S2, the control is terminated.

If the determination result is Yes in step S2, the ECU 3 executes the reduction control (step S3). The reduction control is a process of reducing the number of operations of the INJ 26a as compared with the case of No in step S2. Specifically, the reduction control executes an upper limit value change process and a switching value change process. Step S3 is an example of a process executed by the reduction control unit.

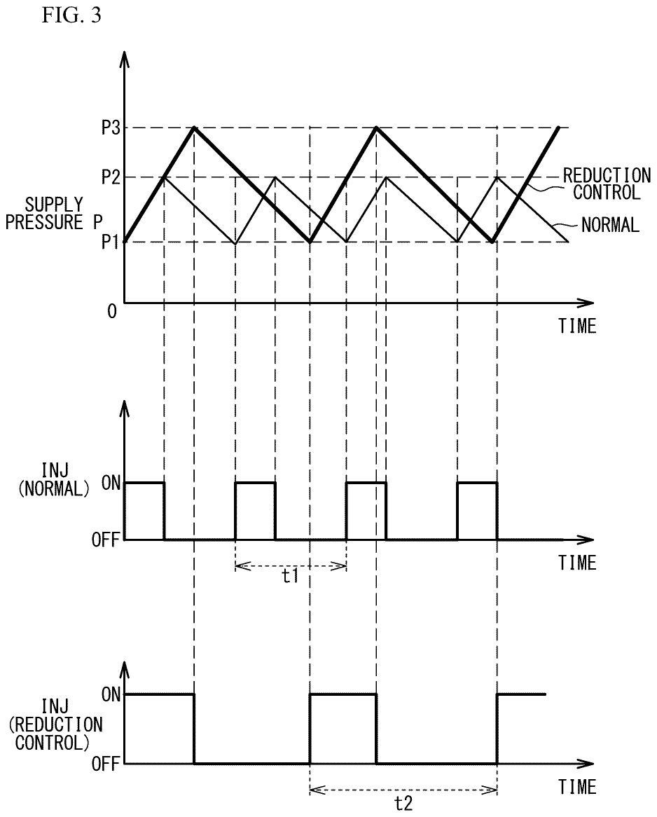

FIG. 3 is a timing chart illustrating the upper limit value changing process. FIG. 3 illustrates the supply pressure values P and the ON/OFF states of the INJ 26a in a normal state and a reduction control state. In the normal state, when the supply pressure value P is reduced to a pressure value p1 as a lower limit value, the INJ 26a is controlled to be turned on, and the INJ 26a is operated. As a result, the fuel gas is injected from the INJ 26a, and the supply pressure value P rises. When the supply pressure value P rises to a pressure value p2 as an upper limit value, the INJ 26a is controlled to be turned off, and the operation of the INJ 26a is stopped. As a result, the injection of the fuel gas from the INJ 26a is stopped, and the supply pressure value P is reduced. The pressure value p2 is higher than the pressure value p1. In this way, in the normal state, the INJ 26a is switched on and off in a period t1. The above process is an example of a process executed by the operation control unit.

In the upper limit value changing process, the upper limit value is changed from the pressure value p2 to a pressure value p3. The pressure value p3 is higher than the pressure value p2. Therefore, in the reduction control, the INJ 26a is controlled to be turned on when the supply pressure value P is reduced to the pressure value p1 as the lower limit value, like the normal state. However, during the reduction control, unlike the normal control, the INJ 26a is controlled to be turned off when the supply pressure value P is increased to the pressure value p3 as the upper limit value. Therefore, during the reduction control, the INJ 26a is switched between ON and OFF at a period t2 longer than the period t1. Therefore, the number of operations of the INJ 26a is reduced in the reduction control as compared with the normal state. This improves the life of the INJ 26a. Further, although the number of operations of the INJ 26a is reduced, the INJ 26a is continuously driven. Thus, the supply pressure value P is accurately maintained between the pressure values p1 and p3.

In the upper limit value changing process, the lower limit value is not changed and is maintained at the value p1. This suppresses a decrease in the output of the FC 4 due to a shortage of the fuel gas. The difference between the pressure values P3 and P2 may be, for example, equal to or smaller than the difference between the pressure values P2 and P1. This is because if the difference between the pressure values P3 and P2 is excessively larger than the difference between the pressure values P2 and P1, the fuel efficiency deteriorates.

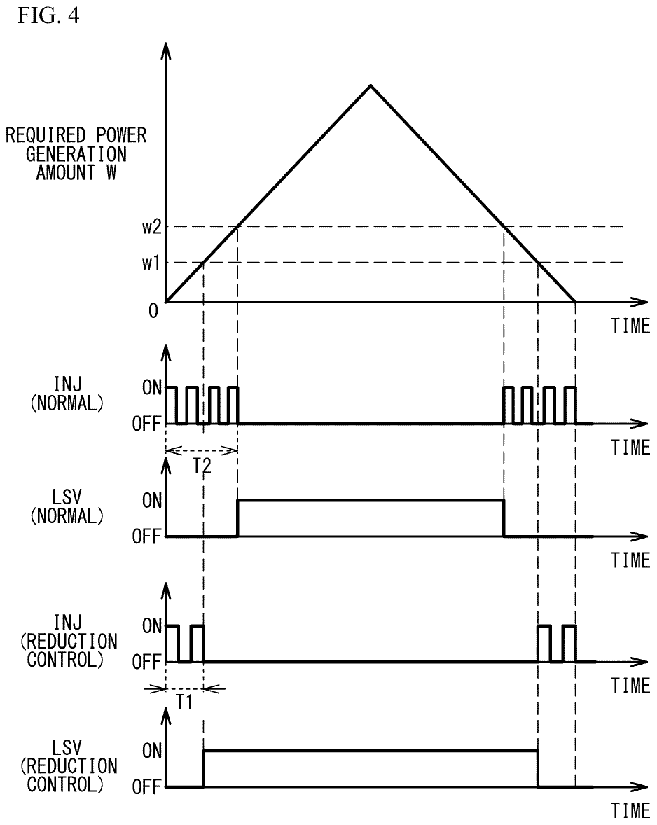

FIG. 4 is a timing chart illustrating the switching value changing process. FIG. 3 illustrates the required power generation amount W of the FC 4 and the ON/OFF states of the INJ 26a and the LSV 26b in the normal state and in the reduction control state. FIG. 3 illustrates a case where the required power generation amount W of the FC 4 increases from 0 and decreases again. In a normal state, when the required power generation amount W is less than a power value w2 as the switching value, the INJ 26a is driven and the LSV 26b is stopped. When the required power generation amount W is equal to or larger than the power value w2, the INJ 26a is stopped and the LSV 26b is driven. In this way, in the normal state, the INJ 26a is driven during a driving time T2. The above process is an example of a process executed by the switching unit.

In the switching value changing process, the switching value is changed from the power value w2 to a power value w1. The power value w1 is lower than the power value w2. In this way, during the reduction control, the INJ 26a is driven for a driving time T1 shorter than the driving time T2. Therefore, the driving time of the INJ 26a is shortened in the reduction control as compared with the normal state. This reduces the number of operations of the INJ 26a and improves the life of the INJ 26a.

Next, the ECU 3 notifies the driver that the number of operations of the INJ 26a is equal to or greater than the threshold value (step S4). For example, the ECU 3 may notify the user by displaying the notification on the display 8, or through a malfunction indicator light (MIL) or a speaker. This is because the fuel efficiency might be deteriorated by the execution of the reduction control described above. Step S4 is an example of a process executed by the notification control unit.

In the above embodiment, both the upper limit value changing process and the switching value changing process are executed as the reduction control. However, only one of the upper limit value change process and the switching value change process may be executed as reduction control.

Although some embodiments of the present disclosure have been described in detail, the present disclosure is not limited to the specific embodiments but may be varied or changed within the scope of the present disclosure as claimed.

What is claimed is:

1. A fuel cell system comprising:
a fuel cell;
an injector that injects fuel gas to the fuel cell;
a linear solenoid valve that injects fuel gas to the fuel cell, an injection flow rate of fuel gas from the linear solenoid valve being greater than an injection flow rate of fuel gas from the injector; and
a control device configured to control the injector and the linear solenoid valve,
wherein the control device is configured to include:
a switching unit configured to operate the injector when a required amount of power generation of the fuel cell is less than a switching value, and to operate the linear solenoid valve when the required amount of power generation is equal to or greater than the switching value;
an operation control unit configured to operate the injector when the required amount of power generation is less than the switching value and a supply pressure of the fuel gas supplied to the fuel cell is decreased to be equal to or smaller than a lower limit value, and to stop the operation of the injector when the required amount of power generation is less than the switching value and the supply pressure is increased to be equal to or greater than an upper limit value;
an integration unit configured to integrate the number of operations of the injector; and
a reduction control unit configured to execute reduction control to reduce the number of operations of the injector when the number of operations is equal to or larger than a threshold value, as compared with when the number of operations is smaller than the threshold value.

2. The fuel cell system according to claim 1, wherein the reduction control is configured to change the upper limit value to a higher value while maintaining the lower limit value when the number of operations is equal to or greater than the threshold value, as compared with when the number of operations is less than the threshold value.

3. The fuel cell system according to claim 1, wherein the reduction control is configured to change the switching value to a lower value when the number of operations is equal to or larger than the threshold value, as compared with when the number of operations is smaller than the threshold value.

4. The fuel cell system according to claim 1, wherein the reduction control is configured to change the upper limit value to a higher value and to change the switching value to a lower value while maintaining the lower limit value when the number of operations is equal to or greater than the threshold value, as compared with when the number of operations is less than the threshold value.

5. The fuel cell system according to claim 1, wherein the control device includes a notification control unit configured to notify that the number of operations is equal to or larger than the threshold value when the number of operations is equal to or larger than the threshold value.
